(19) United States
(12) Patent Application Publication
(10) Pub. No.: US 2011/0148621 A1
(43) Pub. Date: Jun. 23, 2011

(54) DEVICE WITH MAGNET ARRANGEMENT

(76) Inventors: Helge Neukirch, Much (DE); Thomas Reuter, Leubsdorf (DE); Eckhard Baermann, Gladbach (DE)

(21) Appl. No.: 12/996,535

(22) PCT Filed: Jun. 3, 2009
(86) PCT No.: PCT/DE09/00777

§ 371 Date: Jan. 13, 2011

(30) Foreign Application Priority Data
Jun. 4, 2008 (DE) 10 2008 026 701.5

(51) Int. Cl. G08B 1/00

(52) U.S. Cl. 340/531

(57) ABSTRACT

The invention relates to a device with a magnet arrangement having at least one permanent magnet, where the device displays a magnetically active, first contact surface for fixing it in place in a contact position on a magnetisable base.

To extend the possible uses of the device, it is proposed that a signal-emitting functional device (6) having a functional element (6.1) be provided that can be actuated automatically to trigger the signal when the first contact surface (5) of the device (V) contacts the base (U), either by the dead weight of the device (V) or parts thereof and/or by the force of magnetic attraction acting between the first contact surface (5) and the base (U).

The invention relates to a device with a magnet arrangement having at least one permanent magnet, where the device displays a magnetically active, first contact surface for fixing it in place in a contact position on a magnetisable base.

Known devices with a magnet arrangement, e.g. in the form of organisation magnets, generally serve to hold objects, such as papers, photographs and the like, in place on a magnetisable base. The magnetisable base can be ferromagnetic, as in the case of a magnetic board, or paramagnetic.

The object of the invention is to extend the possible uses of the device.

According to the invention, the formulated object is solved by the characteristics of claim 1. Advantageous developments are described in the sub-claims. In particular, the formulated object is solved by providing a signal-emitting functional device having a functional element that can be actuated automatically to trigger the signal when the first contact surface of the device contacts the base, either by the dead weight of the device or parts thereof and/or by the force of magnetic attraction acting between the first contact surface and the base.

Automatic actuation is intended to mean that no further action has to be taken to this end. The signal can, for example, be an optical, acoustic and/or mechanical signal. For instance, the device can be designed as a toy where, for example, a tune is played as the signal, or a story read out loud. Similarly, the device can be an advertising object whose signal is in the form of an advertising slogan, for example. The signal can be given in mechanical fashion by, for example, an artificial flower, a figure, an advertising medium, a company logo or an advertising gift popping out of the inside of the device due to the action of a spring.

The signal can be transmitted, as an open-loop and/or closed-loop control signal, to a facility remote from the device and/or within the device, e.g. to a further functional element of the functional device of the organisation magnet. As a result of the open-loop and/or closed-loop control signal, the functional device can be set to an idle state, in which it can, for example, be activated, set to a quiescent state or switched off as a result of an external signal.

To activate the functional device, a signal can, for example, be given upon occurrence of certain events, such as a noise, electromagnetic radiation, e.g. in the form of visible light, jarring or vibration of the device, or a change in a field surrounding the device and/or in the material environment of the device, e.g. in the form of smoke (smoke alarm), heat (fire alarm) or a liquid (level indicator in tanks or silos).

Since the device is designed to adhere magnetically to a magnetisable base by means of its first contact surface, and its functional device can be actuated automatically in the first contact position, it can also be used in locations that are poorly accessible during operation, e.g. in pipes, and/or that are contaminated and/or evacuated, e.g. in nuclear power stations. The locations can also display an atmosphere having a certain, hostile composition. In particular, the device can be used in locations requiring additional monitoring, illumination or other functions of the functional element or the functional device that were perhaps previously not planned. In addition to the function of holding paper or the like on a magnetisable base, this creates a host of potential additional functions for the device.

The functional device can display a sensor. An open-loop and/or closed-loop control signal for the functional element and/or for a facility outside the device can be automatically generated by means of the sensor in the first contact position. The sensor can be geared to signals outside and/or inside the device.

The sensor can be sensitive to incoming electromagnetic, magnetic, electric, piezoelectric, pneumatic, hydraulic, acoustic, thermal and/or haptic signals. Thus, if the device is put down with its first contact surface on a table top, for example, or if the first contact surface is blacked out, the functional device can be automatically switched on or off by means of a control signal initiated by a light sensor when the device is put down. The sensor can furthermore be sensitive to a composition of a medium surrounding the device and/or a change therein. The sensor can thus respond to the evolution of smoke, for example. The sensor can be sensitive to contact with a base, via a pressure sensor or a contact-operated switch, for example. The sensor can generate the open-loop and/or closed-loop control signal in response to a certain vibration of the device.

The open-loop and/or closed-loop control signal can be transmittable to the functional element of the functional device and/or to a facility outside the device. Signal transmission to the functional element of the functional device is preferably accomplished in hard-wired fashion, since this is simple, signal transmission to a facility outside the device preferably being accomplished in wireless fashion. The latter measure permits at least almost unrestricted relocation of the device.

The device can be designed as a multifunctional unit. To expand the possible functions of the device, among other things, provision can be made for a functional element and/or a sensor to be assigned to each contact surface. Thus, for example, each contact surface can be provided with light sensor that activates a functional element designed as a lighting unit to emit light when the quantity of light is below a certain level. Or a sensor can be provided that activates several functional elements. Also, a sensor and a functional element can be assigned to each contact surface. Thus, for example, a display device, e.g. for the illuminated display of a company logo, can be provided on one contact surface, and a lighting unit with one or more LEDs as lamps on another surface, while a third contact surface displays an alarm device, for example.

The functional device can be designed to be activated and/or switched on when the device is moved into the first contact position and/or to be deactivated and/or switched off when moved out of the first contact position.

Several functional elements and/or sensors can also be assigned to one contact surface. Also, a sensor and/or a functional element can be assigned to a side surface of the device that is not a contact surface, in which context the functional element or the functional device can be designed to be actuated automatically by means of the functional device when the device is put down on its contact surface. Also, a functional element that is assigned to one contact surface in terms of its action can be activated or actuated by means of a sensor in another first contact surface. Positioning of the device on a first contact surface can have the effect that the functional device is merely activated, i.e. that a further associated sensor and/or an associated functional element is activated.

The device can be designed as an organisation magnet, which can display a magnetically active, second contact surface for fixing it in place on the base in a second contact position. This second contact surface can thus merely serve to fix the device in place. To expand the functions of the second contact surface, a functional element and/or a sensor can be assigned to it. Via the sensor, a signal can, for example, be triggered by means of the functional device when in the second contact position, as a result of which the functional device or the functional element can be deactivated and/or switched off. The device can display several second contact surfaces.

The sensor can be designed as a switch for actuating the functional element that is sensitive to contact with the base and/or to light, and can be arranged in the device in such a way that it can be actuated when the device is in contact with, or brought into contact with, the base in the first contact position. The switch can, for example, be coupled to a light sensor that is blacked out upon contact with the base, thereby actuating the switch. If placed on a sheet of glass and exposed to daylight, the associated functional element can be switched on or off above or below a certain level of residual light when darkness sets in.

The switch can, for example, be an optical switch that is preferably coupled to a photoelectric cell as the sensor. The switch can be a gravity switch. As such, the switch can display an electrically conductive fluid that moves under gravity, connecting the switch contacts conductively in an ON position and releasing the switch contacts in an OFF position, thereby interrupting them.

The switch can be designed as a contact-sensitive switch that is actuated in contact with the base. Thus, if the organisation magnet is put down with its second contact surface on a table top, for example, the lighting and/or display device can be automatically switched on or off when the device is put down. Automatic switching-on of the lighting and/or display device is preferably provided for in this context. The organisation magnet can thus serve as a lighting unit in the first contact position. In the first contact position, it can furthermore be used to hold objects in place on the table top under the influence of its own weight, and thus as a paperweight.

The switch can be designed as a push-button switch. The button can extend outwards, through the first contact surface and/or the second contact surface, and project outwards beyond said contact surface by an amount that is slightly greater than, or equal to, a switching travel for actuating it. The push-button switch can thus be actuated when the organisation magnet contacts the base. Depending on the required function, the push-button switch can be designed as a normally open or normally closed contact. The push-button switch is preferably designed as a normally open contact, particularly if its button extends through the first contact surface and projects beyond it. The force for actuating the push-button switch is expediently smaller, preferably substantially smaller, than the dead weight of the device and/or the magnetic force that the device can exert on the base.

The functional device is preferably activated and/or switched on in the first contact position. The functional device can be deactivated and/or switched off in the second contact position.

The sensor is preferably designed as a magnet-operated switch for actuating the functional device. The magnet-operated switch is advantageously located in the device in such a way that it can be actuated under the influence of the magnetic field of the magnet arrangement when the device is in contact with, or brought into contact with, the base in the first contact position. In a preferred embodiment of the device, the magnet-operated switch is designed as a reed switch. In keeping with its function, the reed switch can be located in the device in such a way that, when the device is in contact with, or brought into contact with, the base in the first contact position, it can move at least roughly in and opposite to the direction of compression of the magnetic field lines of the magnetic field of the magnet arrangement as a result of gravity in order to be actuated. It is commonly known that reed switches have magnetisable contacts that can be closed against their spring force when magnetised, and opened when the magnetisation drops below a certain magnetisation level. Thus, when the reed switch moves in the direction of compression of the magnetic field lines of the magnetic field of the magnet arrangement, the contacts can be magnetised and the switch therefore closed. Accordingly, the contacts can be opened in the opposite direction. A switching impulse can thus be triggered in both cases.

The contacts are preferably located in a hollow glass body for protection.

The magnet arrangement can comprise an interior space in which the functional element is located. In this context, not only the first contact surface or first contact surfaces, but also a second contact surface or several contact surfaces can each display an associated interior space for a functional element,

It goes without saying that the magnetic induction, acting on the contact surface and generated by means of the magnet device, must be high enough to generate a magnetic force of attraction acting between the first contact surface and the base, by means of which the device can be fixed in place on the base against the force of gravity and/or the signal-emitting functional device can be automatically actuated to trigger the signal when the device or the organisation magnet is brought into contact.

The magnet arrangement can display a surface designed as a magnetically active side, In this context, the active side is taken to be the surface of the magnet arrangement where the maximum magnetic flux density emerges. This means the end faces in the case of a bar magnet, for example, or the annular end faces in the case of a hollow, cylindrical permanent magnet. The active side of the magnet arrangement is expediently located near to or adjacent to the associated contact surface, or forms at least part of it. The active side is preferably arranged parallel to the associated contact surface. The magnet arrangement preferably displays at least two permanent magnets on at least one of its magnetically active sides.

The permanent magnet of the magnet arrangement can have basically familiar pole arrangements. The permanent magnet can be axially magnetised. The permanent magnets can also be laterally magnetised on one side, with at least one pair of poles each.

The magnet arrangement preferably displays a permanent magnet made of a hard magnetic material, which can consist of samarium-cobalt, neodymium-iron-boron (NdFeB) or a martensitic steel, for example. A magnet made of hard ferrite is preferred, preferably on the basis of barium and/or strontium. The magnet can be a sintered powder magnet. As the magnetic material, the permanent magnet preferably displays a rubber-like, flexible, preferably skin-compatible plastic, in which magnetic materials in powder form are embedded, preferably Sr ferrite or NdFeB.

The magnet arrangement can display a ring magnet with two magnet face ends that has single axial polarisation or bilateral, multiple-pole axial polarisation. The ring magnet can have the form of a hollow cylinder. The axial magnetisation is preferably such that uniform polarisation is obtained at each of the magnet face ends, where the one magnet face end has a magnetic polarity opposite to the polarity of the other magnet face end. The magnet face ends can thus form the active sides of the magnet arrangement. The magnet face ends are preferably each assigned to a contact surface to act as magnets. They can also each form a contact surface.

The permanent magnet can be a magnetic foil and/or magnetic strip, in each case with two apposite larger side surfaces, where the magnetic foil or magnetic strip is polarised axially, i.e. perpendicularly to its respective larger side surfaces. In this context, in the case of a plane arrangement of the magnetic foil or magnetic strip in the magnet arrangement, at least one larger side surface can form the active side of the magnet arrangement. The magnetic foil and/or magnetic strip can display alternating magnetic polarisations over their lateral extension.

The permanent magnet can be coiled into a magnetic spiral having at least one magnetic strip, where the magnetic strip is coiled into the magnetic spiral over its larger side surfaces. This arrangement makes it possible to substantially increase the magnetic induction at the face ends in comparison with plane magnetic foils. In this context, the face ends of the magnetic spiral can form the magnetically active sides of the magnet arrangement, at least one of which is located along the contact surface, or at least roughly parallel to it. The face ends can each be assigned to a contact surface. They can also form said surface, at least partially.

As mentioned above, the functional element can be of very different kinds, where particular preference is given in this context to kinds that can be miniaturised and/or predominantly be used in the home, office, motor vehicle and/or in poorly accessible locations. The functional element can, for example, be an electronic communication device, such as a microphone and/or transmitter section of a baby phone, a camera, a telephone or an interface to the Internet or to other electronic devices, a consumer electronics device, such as a radio, television or CD and/or DVD player, a clock whose alarm function, for example, can be activated or deactivated in the contact position, a colour-changing outer layer of the device or the organisation magnet, or a source of one or more forms of electromagnetic and/or thermal radiation.

The functional element can be based on a mechanical mechanism. This can, for example, have a wind-up, spring-driven clockwork as a drive, via which an element can be moved mechanically. The functional element can be designed as a hinged or pop-up mechanism with a spring-loaded flap, preferably located in a side surface, where the flap can pop open by means of spring force upon setting down on the second contact surface, and where, by means of a further spring force, a figure, an advertising medium, a company logo and/or a text can appear or pop out of the device or the organisation magnet through the flap as a signal.

It is particularly proposed that the functional element be designed as a lighting and/or display device with a lamp capable of emitting light as a signal. The lighting and/or display device can, for example, be used for direct and/or indirect illumination of an object. For advertising purposes, for example, the lighting and/or display device can be used to illuminate and/or transilluminate a text, an image, a logo, a symbol or the like, where the display can be two- or three-dimensional. The lighting and/or display device is preferably switched off automatically in the first contact position. In the first contact position, the first contact surface of the device lies on a base. In this contact position, the device can serve as an organisation magnet for fixing or holding objects on the base. The lighting and/or display device, or at least the greater part thereof, is preferably located in the interior space of the magnet arrangement or the magnet.

When the second contact surface of the device makes contact, the lighting and/or display device can be switched on automatically and emit light. Expediently, at least one side surface of the organisation magnet, particularly the second contact surface, displays an opening for radiating the light emitted as a signal by the lamp. Light guides can be provided, thanks to which the light generated by the lighting and/or display device is radiated, preferably laterally on the organisation magnet. As a result, the organisation magnet can, for example, serve as a shining, but not dazzling, route marker, simultaneously holding an information sign or similar, for example.

The lighting and/or display device can be switched on when the device or the organisation magnet is put down on its first contact surface. The organisation magnet can thus serve as a lighting unit.

The second contact surface can enclose an angle less than or equal to 180° with the first contact surface. The second contact surface can face away from the first contact surface, at least with one directional component. The contact surfaces are preferably arranged parallel to each other. This simplifies the structure of the device or the organisation magnet.

The device can display a housing with several side surfaces, at least two of which are designed as contact surfaces, Three and more contact surfaces can be provided, preferably two first contact surfaces and one second contact surface, Every side surface can be designed as a contact surface. The form of the contact surface can be adapted to the base. The first contact surface, in particular, can display a further retaining mechanism, such as a Velcro fastener, an increased surface roughness, ribbing, a projection or spike or a recess for forming a plug-in connection and/or a sucker, for fixing the device on the base.

The housing can display a polyhedral shape. A plurality of first and/or second contact surfaces can be provided in this context. This permits the correspondingly diverse disposition of functional elements, and thus the expansion of different functions of the device or the organisation magnet, for example. Every side surface of the polyhedral shape can be designed as a contact surface. An arrangement of contact surfaces can be provided, according to which a contact surface is adjacent to side surfaces of the polyhedral shape that are not designed as contact surfaces. The contact surfaces can also be concentrated to extend over an area, or several areas, with adjacent side surfaces. Furthermore, the polygonal form of the housing makes it possible to achieve aesthetic styling of the device. The housing preferably displays the form of a Platonic solid, an Archimedean solid or a Catalan solid.

In one of its developments, the organisation magnet can display a housing having a rotationally symmetrical shape, particularly a cylindrical housing with two housing face ends, a first housing face end and a second housing face end. The housing face ends can form the contact surfaces. The push-button can thus project through the respectively associated housing face end in the manner described above. The reed switch can be arranged in such a way that it can be moved in the direction of the cylinder axis. The magnet face ends expediently lie on the housing face ends on the inside. This makes it possible to minimise the distance between the magnet face ends and the outer side of the housing or the housing face ends. Moreover, the permanent magnet can be fixed in the housing in this way. The permanent magnet can furthermore lie on lateral surfaces of the housing on the inside. Provided on the inner side from the first housing face end can be an axially extending annular projection that, together with the lateral surface of the housing, forms a compartment for receiving the permanent magnet that is adapted to the radial extension of the permanent magnet. The permanent magnet can thus easily be inserted into the compartment when the annular flange is removed.

The lighting and/or display device can be integrated in the magnet arrangement. The lighting and/or display device is preferably located in the interior space encompassed by the permanent magnet, where the permanent magnet is preferably a ring magnet. This makes it possible to achieve a particularly simply structured and yet compact design of the device or the organisation magnet.

Light guides can be provided, so that light emitted on the inside by the lamp and coupled into the light guide can be guided to a specific point and radiated towards the outside. Parts of the housing can be designed as light guides. For example, the second housing face end can be designed as a light guide, via which light emitted on the inside by the lamp and coupled into the light guide can be radiated laterally, such that the device or the organisation magnet can be laterally surrounded by a circle of light, at least around part of its circumference, when set down on its second contact surface.

The second housing face end expediently displays the opening for radiating the light emitted by the lamp. Said opening can thus simultaneously delimit the interior space. The opening can be covered by a transparent panel. The panel can have a particular colour and/or display a motif, such as an advertisement, a company logo or an image, through which light can be transmitted. The panel can display pigments that are thermochromic, hydrochromic or photochromic. As a result, the colour of the panel can change when the panel is exposed to the influence of light, temperature and/or humidity.

The panel is preferably fixed on the housing in a manner permitting replacement. To hold down the panel on the opening, an annular flange can be provided that can preferably be screwed to the housing and reaches over the edge of the panel, and that preferably forms the associated housing face end with the opening.

The lamp can be located in a receptacle provided in the interior space. The receptacle can be located on a printed circuit board. The printed circuit board can display a open-loop and/or closed-loop controller for the lighting and/or display device. The receptacle is preferably located in the interior space below the opening in such a way that a lamp inserted into the receptacle can predominantly radiate towards the opening.

The receptacle can furthermore display customary reflectors for radiating and/or focusing the light emitted as a signal by the lamp. The receptacle can be accessible from the outside via the annular flange described above.

In principle, all customary lamps are open to consideration as the lamp. The device preferably displays a power supply belonging to it. Therefore, use is expediently made of lamps that display low power consumption. For example, an electroluminescent foil can be used as the lamp, and located close to the opening or lying on the opening or the panel, this reducing the necessary design height of the organisation magnet. Preferably, at least one light-emitting diode is provided as the lamp.

The lamps can be of polychromatic or monochromatic design. They can emit light that changes as a function of a supply voltage for the respective lamp, a temperature inside and/or outside the organisation magnet, an ambient brightness or an ambient humidity, for example.

The lighting and/or display device can furthermore display a receptacle, located in the interior space, for a battery or a storage battery as the voltage source. The receptacle can be designed to be accessible via a lockable access opening. The access opening can be located in the first housing face end or another side surface of the organisation magnet. The access opening can be provided with a lock, preferably a bayonet lock. To form the bayonet lock, a cover disk adapted to the access opening can be provided with lateral, radially outward-facing, flat projections that are positioned opposite each other and, in order to fix the cover disk in place, engage slits provided around part of the circumference in the inner wall of the access opening. The outer side of the cover disk preferably displays a slit for non-positive engagement of a tool, particularly a coin.

Combining the receptacles for the voltage source, the printed circuit board and/or the switch, a mounting plate can be provided that can preferably be inserted loosely into the interior space. In this context, the mounting plate can be fixed in position in the housing, preferably clamped, when the annular flange is fixed in position on the housing. Furthermore, the reflector can likewise be inserted into the interior space as a loose component, in which context it is preferably adjacent to the permanent magnet, the panel and the printed circuit board or the mounting plate on the inside, and can be fixed in place or clamped tight in the interior space when the annular flange is fixed in position on the housing. As a result, the permanent magnet can easily be installed and dismantled after removing the annular flange.

All housing parts and/or the mounting plate are preferably plastic injection mouldings.

The present invention is described in more detail below on the basis of several embodiments illustrated in a drawing. The figures show the following:

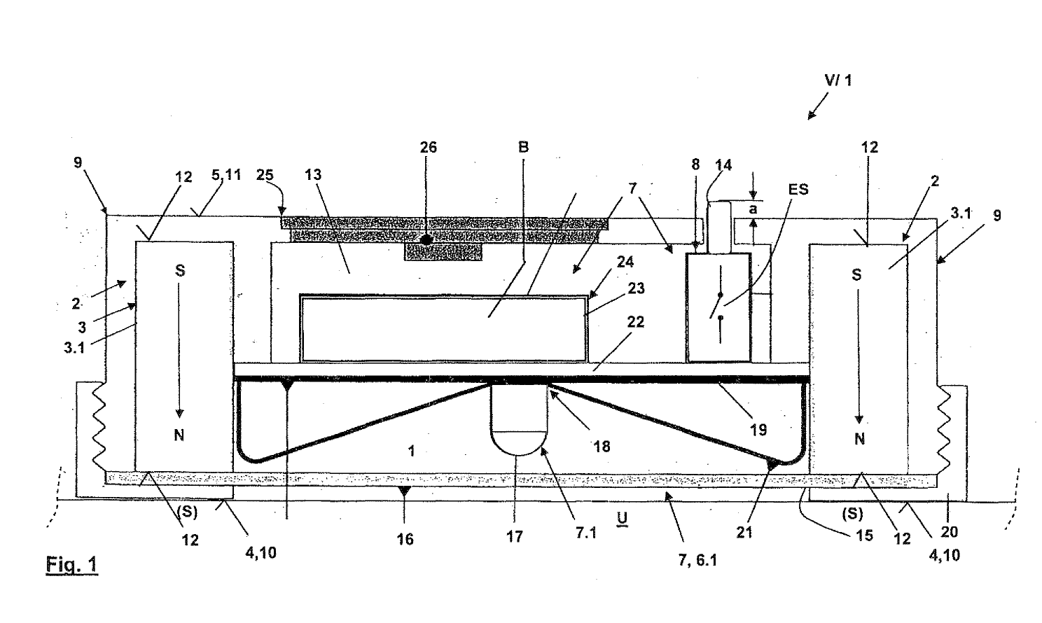

FIG. 1 A longitudinal sectional view of a first embodiment of a device designed as an organisation magnet in a second contact position,

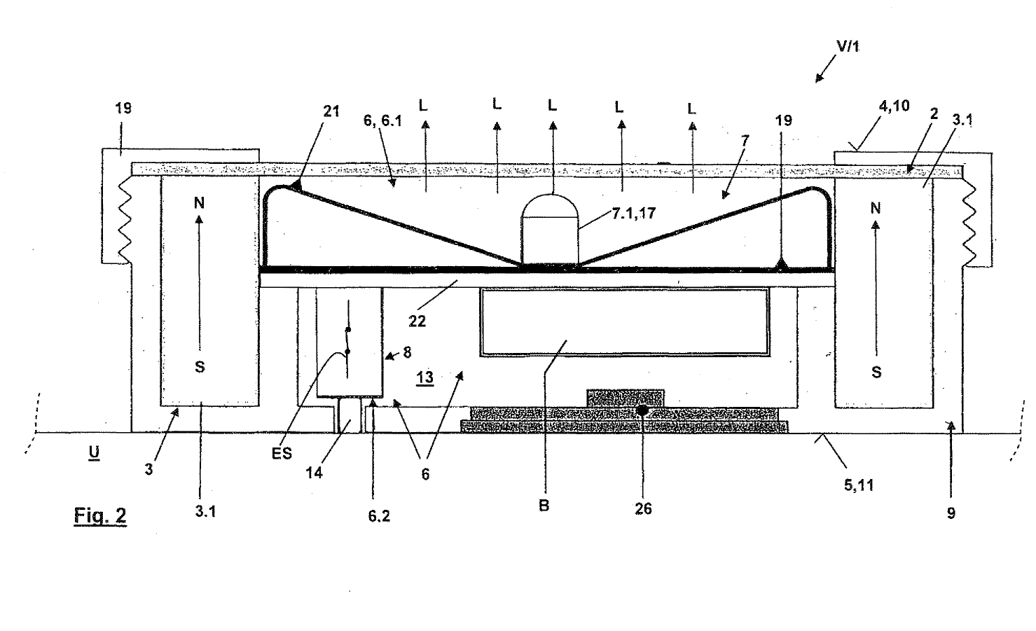

FIG. 2 A longitudinal sectional view of the device according to FIG. 1, but in a first contact position,

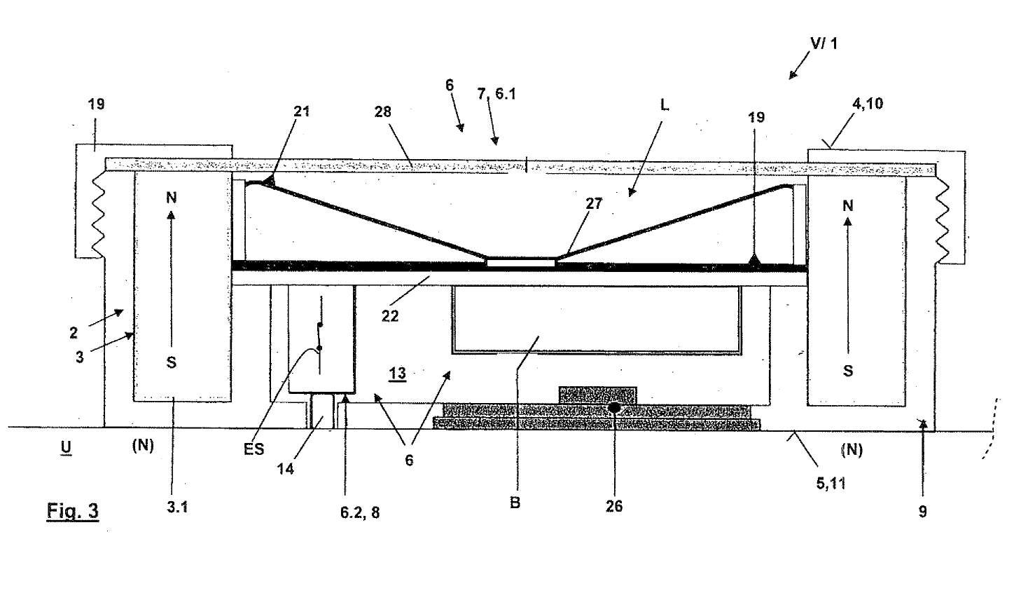

FIG. 3 A longitudinal sectional view of a second embodiment of the device designed as an organisation magnet in the first contact position,

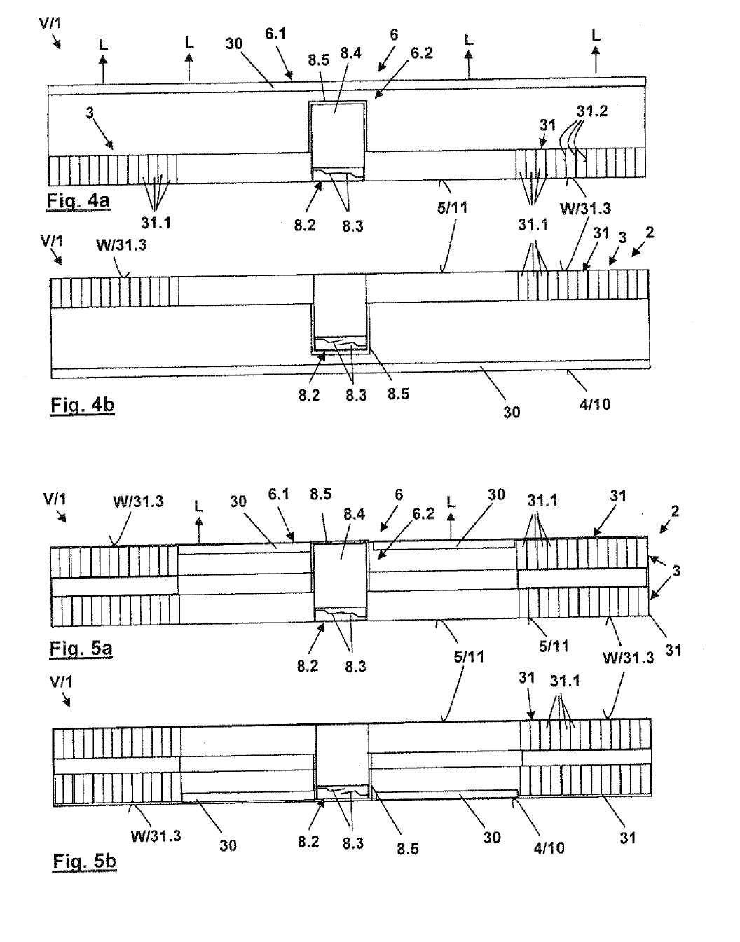

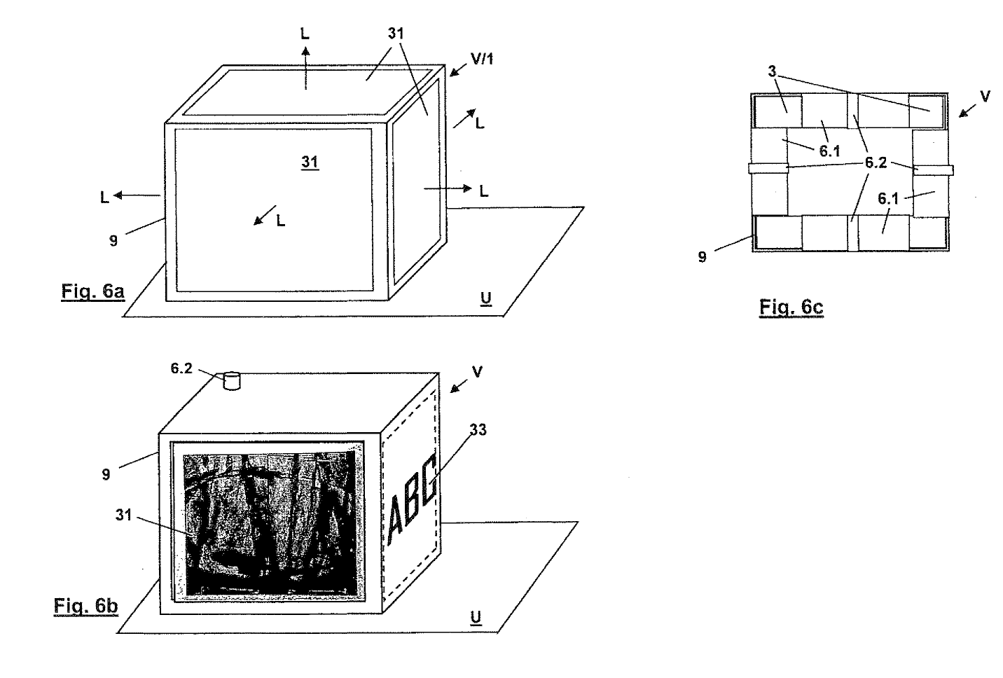

FIGS. 4a and 5a A schematic longitudinal sectional view of a fourth and fifth embodiment, respectively, of the device designed as an organisation magnet in the first contact position,

FIGS. 4b and 5b A schematic longitudinal sectional view of the fourth embodiment and the fifth embodiment, respectively, of the device in the second contact position, and

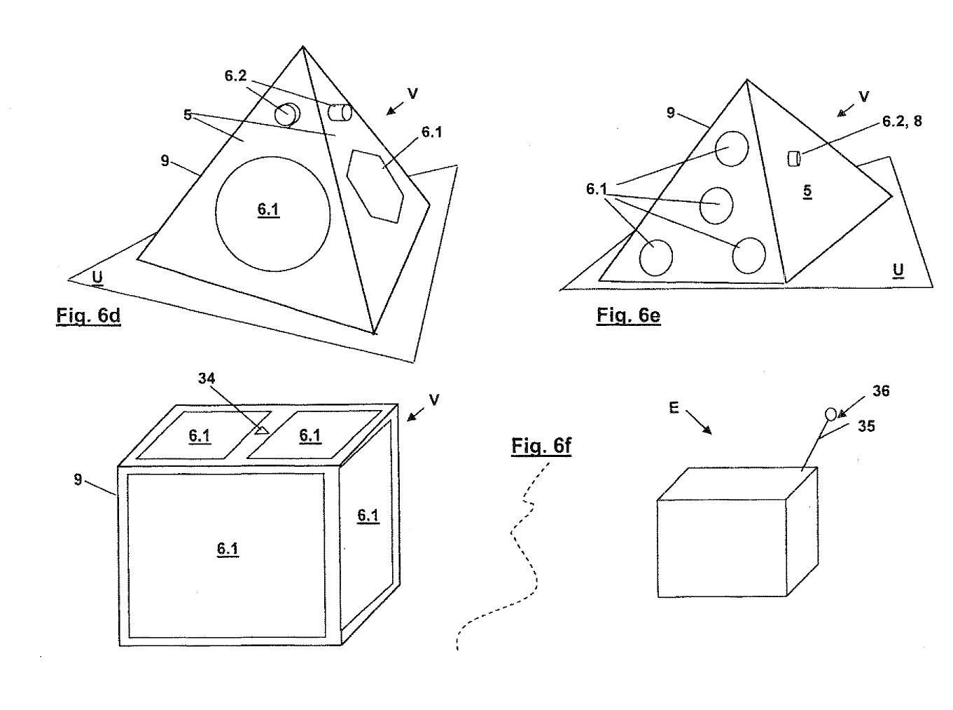

FIGS. 6a to 6f A schematic view of a further embodiment of the device in each case.

FIGS. 1 to 5 show different embodiments of a device V, designed as an organisation magnet 1, with a magnet arrangement 2 having at least one permanent magnet 3. Organisation magnet is shown in a first contact position in FIGS. 2 to 4a and 5a, and in a second contact position in FIGS. 1, 4b and 5b. In both contact positions, organisation magnet 1 lies on a base U, where base U is of magnetisable design in FIGS. 2 to 5 and of non-magnetisable design in FIG. 1. The embodiments of device V shown in FIGS. 6a to 6f are examples particularly pointing out different possible external forms of device V, these illustrations being purely schematic.

Magnet arrangement 2 in FIGS. 1 to 3 displays, as permanent magnet 3, a cylindrical ring magnet 3.1 made of hard ferrite based on barium and/or strontium, which is axially magnetised in the indicated direction in such a way that its magnet face ends 12 display different magnetic polarity. Magnet face ends 12 furthermore form the magnetically active side W of magnet arrangement 2, where the active magnetic flux emerging to the outside is at its maximum. Furthermore, organisation magnet 1 displays two contact surfaces, a first contact surface 5 and a second contact surface 4, on which it lies on base U in a second contact position, shown in FIG. 1, or a first contact position, shown in FIG. 2. Both contact surfaces 4, 5 are magnetically active in the embodiment shown here, meaning that organisation magnet 1 can also be fixed on a magnetisable base U by means of both contact surfaces 4, 5. Contact surfaces 4, 5 are arranged parallel to each other in this instance.

Organisation magnet 1 comprises a functional device 6, by means of which a signal is automatically emitted in a first contact position of organisation magnet 1. Functional device 6 coma prises a functional element 6.1 that, in the embodiment according to FIGS. 1, 2, 4 and 5, is designed as a lighting and/or display device 7 having a lamp 7.1 for emitting light L as the signal. Functional device 6 furthermore displays a sensor 6.2.

First, the design of the device according to FIGS. 1 and 2: In this instance, sensor 6.2 comprises a contact-sensitive push-button switch 8.1. Push-button switch 8.1 can be automatically actuated when organisation magnet 1 is moved into or out of the first contact position, where lighting and/or display device 7 is switched off in the second contact position of organisation magnet I and switched on in the first contact position of organisation magnet 1.

Lighting and/or display device 7 and ring magnet 3.1 are located in a housing 9 with a rotationally symmetrical shape, a circular cylindrical shape in this instance. The housing displays two housing face ends, a first housing face end 11 and a second housing face end 10, which form contact surfaces 5, 4. The two magnet face ends 12 of ring magnet 3.1 are each assigned to a contact surface 4, 5 to act as magnets, and lie on an associated housing face end 10, 11 on the inside.

Lighting and/or display device 7 is positioned in the interior space 10 encompassed by ring magnet 3.1.

Push-button switch 8.1 is designed as a normally open contact. It displays a button 14 that extends outwards through first contact surface 5 and, in the second contact position according to FIG. 1, projects outwards beyond said contact surface by an amount a that is equal to its switching travel for actuating it. When organisation magnet 1. makes contact in the first contact position according to FIG. 2, button 14 of push-button switch 8.1 is in this instance pressed into push-button switch 8.1 simply by the dead weight of organisation magnet 1, because base U in FIG. 2 is of non-magnetisable design, as a result of which lighting and/or display device 7 is switched on. This is indicated by an electrical symbol ES on push-button switch 8.1 in FIG. 2. In this instance, organisation magnet 1 thus functions as a lighting unit in the second contact position.

In this instance, the force for actuating button 14 is designed as roughly 0.3 N, whereas the dead-weight force of organisation magnet 1 is in this instance roughly 0.4 N and thus slightly greater than the force for actuating push-button switch 8.1. Consequently, when organisation magnet 1 is set down on first contact surface 5, reliable actuation of push-button switch 8.1 is even guaranteed if the contact surface forms an acute angle with the horizontal. Since first contact surface 5 is in this instance likewise magnetically active, and assigned to a magnet face end 12 designed as active side W, organisation magnet 1 can also adhere magnetically to the magnetisable base U shown in FIG. 1. Due to ring magnet 3.1 being made of hard ferrite, the magnetic force is sufficiently great, even in an overhead position, to securely hold organisation magnet 1 while button 14 is simultaneously pressed in, meaning that organisation magnet 1.3 can, even in its function as a lighting unit, adhere to a magnetisable base U in the first contact position in any desired location.

The first housing face end 11 displays an opening 15, delimiting interior space 13, for radiating the light L emitted as a signal by lamp 6, where opening 15 is covered by a transparent panel 16. Lamp 6 is designed as a light-emitting diode (LED) 17 in this instance. Light-emitting diode 17 is located in a receptacle 18 below opening 15 in interior space 13. Receptacle 18 is centrally integrated in a printed circuit board 19, where the edge of printed circuit board 19 borders on ring magnet 3.1 to fix it in place. Printed circuit board 19 displays a controller, not shown in more detail here, for controlling lighting and/or display device 7. Panel 16 is retained on the housing face end by means of an annular flange 20 that can be screwed onto housing 9, where annular flange 20 overlaps the edge of panel 16 and delimits opening 15. Receptacle 18 is readily accessible via screw-fitting annular flange 20.

Furthermore, reflectors 21 are provided for radiating and focusing the light L emitted as a signal by lamp 6 or light-emitting diode 17.

Lighting and/or display device 7 displays a mounting plate 22, located in interior space 13, with a receptacle 24, located on mounting plate 22 and designed as a battery compartment 23 for a battery B serving as the voltage source. In this instance, push-button switch 8.1 is simultaneously fixed in mounting plate 22, which is of compact design in this instance. Furthermore, printed circuit board 19 is fixed on the side of mounting plate 22 facing towards opening 15. Organisation magnet 1 thus displays a simple structure, with housing 9, mounting plate 22 and ring magnet 3.1.

Because of its small size, a so-called button cell battery is provided as battery B in this instance. To permit simple battery replacement, a lockable access opening 25 in first housing face end 11 is provided in first contact surface 5, through which battery compartment 23 is accessible. Access opening 25 can be locked by means of a bayonet-type lock 26.

The embodiment of organisation magnet 1 illustrated in FIG. 3 particularly differs from the embodiment of organisation magnet 1 shown in FIG. 1 as regards the design of functional element 6.1, which is in this instance designed as a loudspeaker 27 with a loudspeaker membrane 28 and a loudspeaker cover 29. Like that in accordance with FIG. 2, organisation magnet 1 lies with its first contact surface 5 on base U, where the latter is magnetisable, as indicated by the polarity symbol N shown in parentheses in FIG. 3. Thus, although not shown here, overhead positioning of organisation magnet 1 on the base is also possible if said base is located above organisation magnet 1.

FIGS. 4a and 5a each show a schematic, longitudinal sectional view of a fourth and fifth embodiment of device V, designed as organisation magnet 1, in the first contact position, FIGS. 4b and 5b correspondingly showing said device V in the second contact position. For the sake of clarity, FIGS. 4 and 5 merely show a purely schematic illustration of magnet arrangement 2, functional device 6 with functional element 6.1 and sensor 6.2, and housing 9 with first housing face end 11 and second housing face end 10.

In this instance, magnet arrangement 2 displays, as the permanent magnet, a magnetic spiral 31, coiled from a magnetic strip 31.1. As the magnetic material, magnetic strip 31.1 displays a rubber-like, flexible plastic in which magnetic materials in powder form are embedded, in this instance Sr ferrite or NdFeB. The magnetic strip (31.1) is coiled into the magnetic spiral (31) over its larger side surfaces (31.2). Before being coiled into magnetic spiral 31, the magnetic strip (31.1) was magnetically polarised axially, i.e. perpendicularly to its larger side surfaces (31.2). This achieves a particularly strong magnetic field at face ends 31.3.

As a result of this arrangement, face end 31.3 of magnetic spiral 31 forms active side W of magnetic spiral 31, designed as permanent magnet 6, or of magnet arrangement 2. In this context, the outward-pointing face end 31.3 in each case forms an area of first contact surface 5 (FIG. 4) or contact surfaces 4, 5 (FIG. 5), since two magnetic spirals 31 are provided in the embodiment of device V according to FIG. 5. In this instance, an electroluminescent foil 30 is in each case provided as lamp 7.1 of lighting and/or display device 7, forming second contact surface 4 in accordance with FIG. 4 and, according to FIG. 5, a ring-like part of second contact surface 4, together with face end 31.3 of the upper magnetic spiral 31 in FIG. 5a. Electroluminescent foil 30 is of ring-like design in FIG. 5. Provided as sensor 6.2 in the embodiments of device V according to FIGS. 4 and 5 is a gravity-sensitive magnet-operated switch in the form of a so-called reed switch 8.2. Reed switch 8.2 displays two contacts 8.3, which can be magnetised in the magnetic field in such a way that they attract each other in the magnetic field, thus closing reed switch 8.2. This is the case in FIGS. 4a and 5a. In this instance, reed switch 8.2 is located perpendicularly to contact surfaces 4, 5 in sliding fashion in a switch compartment 8.4, dropping into a first position under the influence of gravity.

In FIGS. 4a and 5a, reed switch 8.2 is located close to first contact surface 5 and exposed to the magnetic field of magnetic spiral 31 located there. As a result of this, its contacts 8.3 are magnetically polarised, thereupon magnetically attracting each other and touching. In FIGS. 4b and 5b, second contact surface 4 of organisation magnet 1 is lying on the base not shown here. In this context, reed switch 8.2 has, under the influence of gravity, dropped or shifted into a second position in switch compartment 8.4, where it is subject to only marginal or no magnetic influence. As a result, its contacts 8.3 cease to be magnetically polarised, whereupon they move apart from each other: reed switch 8.2 is open. In this context, a magnetic shield 8.5 is provided that largely shields this part of switch compartment 8.4 from the magnetic field of magnetic spiral 31 (FIG. 4) or magnetic spirals 31 (FIG. 5).

FIGS. 6a to 6e show schematic drawings of further embodiments of device V in order to illustrate further possible uses of device V. In all embodiments, device V displays a polyhedral housing 9 with a polyhedral external form.

Housing 9 is of hexahedral design in FIG. 6a, where each of the six side surfaces is designed as a contact surface 4, 5. In this instance, device V lies on base U with one of its first contact surfaces 5 acting as its supporting surface, as a result of which its functional device 6 is switched on or activated. The remaining contact surfaces, five in this instance, are each assigned a functional element 6.1 in the form of lighting and/or display device 7, which displays a lamp 7.1 in the form of an electroluminescent foil 30, illustrated schematically in the drawing in this instance. In the second contact position shown here, electroluminescent foils 30 emit light L on all five sides of device V, meaning that device V is illuminated all around, except on the supporting surface in this instance.

In FIG. 6b, device V comprises a lighting and/or display device 7 that displays a different embodiment on each of its first contact surfaces 5, which are lateral surfaces in this instance. On first contact surface 5 at the front here, an image 32 is transilluminated by means of an electroluminescent foil 30 serving as lamp 6, while a logo 33 comprising a sequence of letters is made visible on contact surface 5 on the right here.

FIG. 6c shows a sectional view of a cube-like device V, where all the components illustrated are sectioned. In this instance, each contact surface 4, 5 is assigned a functional element 6.1 and a sensor 6.2, all of which are located in interior space 13 of magnet arrangement 2, Magnet arrangement 2 displays two ring magnets 3.1, where one is assigned to the upper side and one to the lower side in this instance.

The embodiment of device V according to FIG. 6d displays a tetrahedral housing 9. As suggested by the different outlines in the form of a circle and a hexagon, functional elements 6.1 are of different designs. Both are each assigned a sensor 6.2.

Figure Se shows an embodiment of device V with several functional elements 6.1 in one of its lateral surfaces, where a sensor 6.2 in the form of a push-button switch B is located in second contact surface 5, activating functional elements 6.1 when the organisation magnet is set down on first contact surface 5. In this context, the functional elements display several light-emitting diodes, covered by panels 16, that are controlled by program by means of an integrated master computer, not shown here.

Figure bf illustrates the functional principle according to which a facility E, remote from device V, is controlled by an open- or closed-loop system. The distance between device V and facility E is symbolised by a broken line between the two. In this instance, provision is made for wireless transmission of a corresponding open- or closed-loop control signal that is symbolised by a transmitter 34 on device V and by a receiver 36 on remote facility F, indicated by an aerial 35.

### LIST OF REFERENCE NUMBERS

1 Organisation magnet

2 Magnet arrangement

3 Permanent magnet

3.1 Ring magnet

4 Second contact surface

5 First contact surface

6 Functional device

6.1 Functional element

6.2 Sensor

7 Lighting and/or display device

7.1 Lamp

8.1 Push-button switch

8.2 Reed switch

8.3 Contact

8.4 Switch compartment

8.5 Shield

9 Housing

10 Second housing face end

11 First housing face end

12 Magnet face end

13 Interior space

14 Button

15 Opening

16 Panel

17 Light-emitting diode

18 Receptacle

19 Printed circuit board

20 Annular flange

21 Reflector

22 Mounting plate

23 Battery compartment

24 Receptacle

25 Access opening

26 Lock

27 Loudspeaker

28 Loudspeaker membrane

29 Loudspeaker cover

30 Electroluminescent foil

31 Magnetic spiral

31.1 Strip

31.2 Side surface

31.3 Face end

32 Image

33 Logo

34 Transmitter

35 Aerial

36 Receiver

a Amount

B Battery

E Facility

ES Electrical symbol

L Light

V Device

1.-25. (canceled)

26. Device with a magnet arrangement having at least one permanent magnet, where the device displays a magnetically active, first contact surface for fixing it in place in a contact position on a magnetisable base, characterised in that a signal-emitting functional device having a functional element is provided that can be actuated automatically to trigger the signal when the first contact surface of the device (V) contacts the base (U), either by the dead weight of the device (V) or parts thereof and/or by the force of magnetic attraction acting between the first contact surface and the base (U).

27. Device according to claim 26, characterised in that the functional device displays a sensor, by means of which, in the first contact position, an open-loop and/or closed-loop control signal can be generated or is generated for the functional element and/or for a facility (E) outside the device.

28. Device according to claim 27, characterised in that signal transmission from the sensor to the functional element of the functional device is accomplished in hard-wired fashion, and signal transmission to a facility (E) remote from the device (V) is accomplished in wireless fashion.

29. Device according to claim 26, characterised in that the functional device can be activated and/or switched on when the device (V) is moved into the first contact position and/or deactivated and/or switched off when moved out of the first contact position.

30. Device according to claim 27, characterised in that the sensor is designed as a magnet-operated switch for actuating the functional device, being located in the device (V) in such a way that, when the device (V) is in contact with, or brought into contact with, the base (U) in the first contact position, it can be actuated under the influence of the magnetic field of the magnet arrangement.

31. Device according to claim 27, characterised in that the sensor is designed as a switch for actuating the functional device that is sensitive to contact with the base (U) and/or to light, being arranged in the device (V) in such a way that it can be actuated when the device (V) is in contact with, or brought into contact with, the base (U) in the first contact position.

32. Device according to claim 26, characterised in that the magnet arrangement displays a magnetically active side (W) that is located along the first contact surface, or at least roughly parallel to it.

33. Device according to claim 27, characterised in that at least two magnetically active first contact surfaces are provided, and in that each first contact surface is assigned a functional element and/or a sensor.

34. Device according to claim 26, characterised in that it displays a housing with several side surfaces, at least two side surfaces of which are designed as first contact surfaces.

35. Device according to claim 26, characterised in that the magnet arrangement delimits an interior space in which the functional element is located.

36. Device according to claim 26, characterised in that the functional element is designed as a lighting and/or display device with a lamp that can be switched by means of the functional device.

37. Device according to claim 34, characterised in that at least one side surface of the housing displays an opening, delimiting the interior space, for radiating the light (L) emitted by the lamp.

38. Device according to claim 26, characterised in that it is designed as an organisation magnet that displays a magnetically active second contact surface for fixing it in place on the base (U) in a second contact position.

39. Device according to claim 38, characterised in that a functional element and/or a sensor is assigned to the second contact surface.

40. Device according to claim 38, characterised in that the housing displays a cylindrical form with two housing face ends, a first housing face end as a first contact surface and a second housing face end as a second contact surface.
